(19) United States
(12) Patent Application Publication
(10) Pub. No.: US 2010/0129713 A1
(43) Pub. Date: May 27, 2010

(54) Carbon-Coated Fluoride-Based Nanomaterials for Anode Applications

(76) Inventors: Rachid Yazami, Los Angeles, CA (US); Cedric M. Weiss, Pasadena, CA (US)

Correspondence Address: GREENLEE WINNER AND SULLIVAN P C, 4875 PEARL EAST CIRCLE, SUITE 200, BOULDER, CO, 80301, US

(21) Appl. No.: 12/574,530

(22) Filed: Oct. 6, 2009

Related U.S. Application Data
(60) Provisional application No. 61/195,334, filed on Oct. 6, 2008.

(51) Int. Cl. H01M 4/62

(52) U.S. Cl. 429/217

(57) ABSTRACT

Electrodes for use in electrochemical cells are provided. The electrode may include a plurality of fluoride-based nanomaterials including calcium or magnesium, wherein a carbon-based film is deposited onto at least some of the nanomaterials. Electrochemical cells comprising the electrodes of the invention are also provided; the electrodes of the invention may act as the negative electrode of the cell.

### CROSS-REFERENCE TO RELATED APPLICATIONS

This application claims the benefit of U.S. Provisional Application No. 61/195,334, filed Oct. 6, 2008, which is hereby incorporated by reference to the extent not inconsistent with the disclosure herein.

### BACKGROUND OF THE INVENTION

A typical battery includes a positive electrode (cathode during discharge), a negative electrode (anode during discharge) and an electrolyte. The electrolyte contains ionic species that are the charge carriers. Electrolytes in batteries can be of several different types: (1) pure cation conductors (e.g., beta Alumina conducts with Na⁺ only); (2) pure anion conductors (e.g., high temperature ceramics conduct with O⁻ or O²⁻ anions only); and (3) mixed ionic conductors: (e.g., some Alkaline batteries use a KOH aqueous solution that conducts with both OH⁻ and K⁺, whereas some lithium ion batteries use an organic solution of LiPF₆ that conducts with both Li⁺ and PF₆⁻). During charge and discharge electrodes exchange ions with electrolyte and electrons with an external circuit (a load or a charger).

There are two basic types of electrode reactions.

1. Cation based electrode reactions: In these reactions, the electrode captures or releases a cation Y⁺ from electrolyte and an electron from the external circuit:

Electrode+Y⁺+e⁻→Electrode(Y).

Examples of cation based electrode reactions include: (i) carbon anode in a lithium ion battery: 6C+Li⁺+e⁻→LiC₆ (charge); (ii) lithium cobalt oxide cathode in a lithium ion battery: 2Li_{0.5}CoO₂+Li⁺+e⁻→2LiCoO₂ (discharge); (iii) Ni(OH)₂ cathode in rechargeable alkaline batteries: Ni(OH)₂→NiOOH+H⁺+e⁻ (charge); (iv) MnO₂ in saline Zn/MnO₂ primary batteries: MnO₂+H⁺+e⁻→HMnO₂ (discharge).
2. Anion based electrode reactions: In these reactions, the electrode captures or releases an anion X⁻ from electrolyte and an electron from the external circuit:

Electrode+X⁻→Electrode(X)+e⁻

Examples of anion based electrode reactions include: (i) Cadmium anode in the Nickel-Cadmium alkaline battery: Cd(OH)₂+2e⁻→Cd+2OH⁻ (charge); and (ii) Magnesium alloy anode in the magnesium primary batteries: Mg+2OH⁻→Mg(OH)₂+2e⁻ (discharge).

Many batteries are either of pure cation-type or mixed ion-type chemistries. Lithium ion batteries are an example of pure cation-type chemistry. The electrode half reactions and cell reactions for a typical lithium ion battery are:
Carbon anode:

6C+Li⁺+e⁻→LiC₆ (charge)
lithium cobalt oxide cathode:

2Li_{0.5}CoO₂+Li⁺+e⁻→2LiCoO₂ (discharge)
cell reaction:

2LiCoO₂+6→2Li_{0.5}CoO₂+LiC₆ (charge)

2Li_{0.5}CoO₂+LiC₆→2LiCoO₂+6C (discharge)

Dual graphite mixed ion-type cells have been described in which the anion intercalates into the positive graphite electrode and lithium intercalates into the negative graphite electrode when the cells are charged. Seel and Dahn report on PF₆⁻ anion intercalation in a dual graphite cell with a LiPF₆-based electrolyte (2000, J. Electrochem. Soc., 147(3), 892-898)

US Patent Application Publication US 2009/0029237 describes an anion-type electrochemical cell comprising a positive electrode; a negative electrode; and an electrolyte provided between the positive electrode and the negative electrode, wherein the electrolyte is capable of conducting anion charge carriers. The positive electrode and negative electrode comprise different anion host materials that reversibly exchange anion charge carriers with the electrolyte during charging or discharging of the electrochemical cell. During discharge, reduction half reactions occurring at the positive electrode result in release of anion charge carriers from the positive electrode to the electrolyte. The anion charge carriers may be fluoride ions (F⁻¹). The negative electrode may be CaFₓ.

As described in US 2009/0029237, the following electrode reactions may occur. In the equations below, A⁻ is the anion charge carrier, PAₙ is the positive electrode anion host material and NAₘ is the negative electrode anion host material.

In a primary battery, only discharge reactions occur:
At the positive electrode, A⁻ is released:

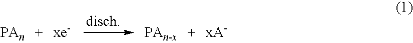

At the negative electrode, A⁻ is occluded

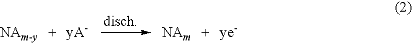

Accordingly, the cell overall reaction is:

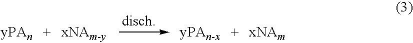

In a rechargeable battery, equations (1) and (2) are reversed during charge, therefore the overall cell reaction is:

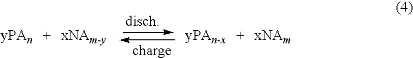

Calcium fluoride is known to conduct fluorine ions (Ure et al., 1957, J. chem. Phys., 26, 1363) and is typically used as an electrolyte in electrochemical cells. GB 1296803 reports electrodes which may contain granules of solid electrolyte comprising doped calcium fluoride. The English abstract of publication of CN1802902 appears to describe incorporation of calcium fluoride in the positive electrode for a nickel-hydrogen battery. Li et al. report electrochemical reactions of a variety of metal fluorides, CaF₂, with lithium in non-aqueous lithium cells at room temperature (Li et al., 2004, J. Electrochem. Soc., 151(11) A1878-1885.

U.S. Pat. No. 4,931,172 reports fluoride ion-selective electrodes which employ a ternary compound of the type MₓLn_{y}F₃₋ₓ as the active membrane component. In this formula, M is an alkaline earth metal ion such as calcium, strontium or barium and Ln is a lanthanide metal ion such as lanthanum, cerium, praseodymium, neodymium, promethium, samarium and europium. The reference describes use of ion-selective electrodes as electrochemical sensors which respond to the concentration of specific ionic species in sample solution.

### SUMMARY OF THE INVENTION

In one aspect, the invention provides an electrode for use in an electrochemical cell. In an embodiment, the electrode comprises an electrode mixture comprising a plurality of fluoride-based nanomaterials comprising calcium, wherein a carbon-based film is deposited onto at least some of the nanomaterials.

In an embodiment, fluoride-based materials useful for the invention may be described by the formula Caₓ M₁₋ₓFₙ, where is M is selected from alkali metals, alkaline-earth metals other than calcium, B, Al, Ga, In, lanthanides and a combination thereof, where the calcium molar composition ‘x’ is 0.03≦x≦0.97 and the fluorine molar composition ‘n” is 0<m≦3. In another embodiment, the fluoride-based material may be described by CaFₘ, where 0<m≦2. In another embodiment, fluoride-based materials useful for the invention may be described by the formula Mgₓ M₁₋ₓFₙ, where is M is selected from alkali metals, alkaline-earth metals other than magnesium, B, Al, Ga, In, lanthanides and a combination thereof, where the magnesium molar composition ‘x’ is 0.03≦x≦0.97 and 0<n≦3. In another embodiment, the fluoride-based material may be described by MgFₘ, where 0<m≦2. These formulas are intended to encompass mixtures of two kinds of fluoride phases (e.g. a mixture of CaF₂ particles and CeF₃ particles) as well as solid solutions (e.g. calcium doped CeF₃).

In an embodiment, the electrodes of the invention are fluoride ion (F⁻) host electrodes and the electrode mixture contains a fluoride ion host material. As used herein, the term “fluoride ion host material” refers to a material capable of accommodating fluoride ions. In this context, accommodating includes insertion of fluoride ions into the host material, intercalation of fluoride ions into the host material and/or reaction of fluoride ions with the host material. The reaction may be a formation reaction in which fluorine ions react with a metal to form a metal fluoride. The reaction may also be a displacement reaction in which fluorine ions displace another species from a binary or more complex phase. In an embodiment, the electrode is a fluoride ion (F⁻) intercalation electrode. In another embodiment, fluoride ions react with the host material of the electrode.

Incorporation of a suitable carbon-based coating on at least some of the fluoride-based nanomaterials in the electrode mixture can improve the capacity of the electrochemical cell.

In another aspect, the invention provides electrochemical cells comprising the electrodes of the invention. Electrochemical cells of the present invention are versatile and include primary and secondary cells useful for a range of important applications including use in portable electronic devices.

In an embodiment, the invention provides an electrochemical cell comprising:

a) a first electrode comprising a current collector and an electrode mixture, the electrode mixture comprising a plurality of fluoride-based nanoparticles; a carbon-based film being deposited onto at least some of the nanomaterials, and a polymeric binder material, wherein at least a portion of the electrode mixture is in electrical contact with the current collector;
b) a second electrode; and
c) a nonaqueous electrolyte provided between said first and second electrodes, said electrolyte being capable of conducting fluoride ions (F); wherein said first electrode reversibly exchanges said fluoride ions with said electrolyte during charging or discharging of said electrochemical cell. In an embodiment, the first electrode is the negative electrode and the second electrode is the positive electrode.

In an embodiment, during discharge of the electrochemical cell, reduction half reactions occurring at the positive electrode result in release of anion charge carriers from the positive electrode to the electrolyte, while at the negative electrode accommodation of anion charge carriers from the electrolyte occurs. During charging, oxidation half reactions occurring at the positive electrode result in accommodation of anion charge carriers from the electrolyte in the positive electrode, while at the negative electrode release of anion charge carriers to the electrolyte occurs.

Typically, the cell will be assembled and then charged prior to the first discharge. For a cell including fluoride-based nanoparticles in the initial negative electrode composition, fluorine ions may be removed from the fluoride-based nanoparticles during such a charging step. The release of fluorine ions from the fluoride-base nanoparticles may result in the formation of an elemental metal phase within the nanoparticles. This elemental metal phase may react with fluorine ions in subsequent discharge steps.

Use of fluoride ion charge carriers in electrochemical cells provides a number of benefits. First, the low atomic mass (18.998 AMU), high electron affinity (−328 kJ mol⁻¹) of fluorine and about 6V redox voltage stability window (from −3.03V vs. NHE to +2.87V vs. NHE) of the fluoride ion (F⁻) can result in electrochemical cells having high voltage, high energy densities and high specific capacities. Second, fluoride ion has a small atomic radius and, thus, can participate in reversible displacement, insertion and/or intercalation reactions in many electrode host materials that do not result in significant degradation or significant structural deformation of the electrode host material upon cycling in secondary electrochemical cells. This property can result in secondary fluoride ion electrochemical cells having a large cycle life (e.g., greater than or equal to about 500 cycles). Third, fluoride ion is stable with respect to decomposition at electrode surfaces for a useful range of voltages (−3.03V vs. NHE to +2.87V vs. NHE), thereby providing enhanced performance stability and safety of electrochemical cells.

In another aspect, the present invention provides a method for making an electrochemical cell comprising the steps of: (i) providing a negative electrode of the present invention; (ii) providing a positive electrode; and (iii) providing an electrolyte between the positive electrode and the negative electrode; the electrolyte capable of conducting anion charge carriers; wherein the negative electrode is capable of reversibly exchanging the anion charge carriers with the electrolyte during charging or discharging of the electrochemical cell.

In another aspect, the present invention provides a method for generating an electrical current, the method comprising the steps of: (i) providing an electrochemical cell; the electrochemical comprising: a negative electrode of the present invention; a positive electrode; and an electrolyte provided between the positive electrode and the negative electrode; the electrolyte capable of conducting anion charge carriers; wherein the negative electrode is capable of reversibly exchanging the anion charge carriers with the electrolyte during charging or discharging of the electrochemical cell; and (ii) discharging the electrochemical cell. The method of this aspect of the present invention may further comprise the step of charging the electrochemical cell. In some embodiments of this aspect of the present invention the anion charge carrier is fluoride ion (F⁻).

### BRIEF DESCRIPTION OF THE FIGURES

FIG. 1: Charge-discharge profiles of a cell with a carbon coated calcium fluoride containing electrode, a lithium electrode and a 1M LiPF6+0.5 M LiF in 1:1 EC/DMC electrolyte.

FIG. 2a shows a transmission electron microscope (TEM) image of several calcium-doped cerium fluoride particles before carbon coating; the average size was about 20 nm. FIG. 2b shows a selected area diffraction image of the TEM image in FIG. 2a. FIGS. 2c and 2d show bright and dark field TEM images, respectively of calcium-doped cerium fluoride particles. FIG. 2e shows a higher resolution TEM image of a calcium-doped cerium fluoride particle.

FIG. 3 shows a plot of Energy Dispersive X-Ray (EDX) analysis for calcium-doped cerium fluoride material; the amount of calcium determined from EDX analysis was 4.7%.b

FIG. 4 shows an x-ray diffraction spectrum of an electrode including carbon-coated calcium-doped cerium fluoride particles.

FIG. 5 shows charge-discharge profiles of a cell with a carbon coated calcium doped cerium fluoride containing electrode, a lithium electrode and a 1M LiPF6 in 1:1 EC/DMC electrolyte. The carbon coating was formed using sugar as a precursor.

FIG. 6 shows charge-discharge profiles of a cell with a carbon coated calcium doped cerium fluoride containing electrode, a lithium electrode and a 1M LiPF6 in 1:1 EC/DMC electrolyte. The carbon coating was formed using ascorbic acid as a precursor.

FIG. 7 shows charge-discharge profiles of a cell with a carbon coated calcium doped cerium fluoride containing electrode, a lithium electrode and a 1M LiPF6 in 1:1 EC/DMC electrolyte. The carbon coating was formed using olive oil as a precursor.

FIG. 8 shows an x-ray diffraction spectrum of a carbon coated calcium doped cerium fluoride containing electrode after discharge in a cell with a lithium anode.

### DETAILED DESCRIPTION OF THE INVENTION

Referring to the drawings, like numerals indicate like elements and the same number appearing in more than one drawing refers to the same element. In addition, hereinafter, the following definitions apply:

“Standard electrode potential” (E°) refers to the electrode potential when concentrations of solutes are 1M, the gas pressures are 1 atm and the temperature is 25 degrees Celsius. As used herein standard electrode potentials are measured relative to a standard hydrogen electrode.

“Anion charge carrier” refers to a negatively charged ion provided in an electrolyte of an electrochemical cell that migrates between positive and negative electrodes during discharge and charging of the electrochemical cell. Anion charge carriers useful in electrochemical cells of the present invention include, but are not limited to, fluoride ions (F⁻), and the following other anions:

BF₄⁻, PF₆⁻, AsF₆⁻, SbF₆⁻, BiF₆⁻, AlF₄⁻, GaF₄⁻, InF₄⁻, TlF₄⁻, SiF₅⁻, GeF₅⁻, SnF₅⁻, PbF₅⁻, SF₇⁻, IF₆⁻, ClO₄⁻, CF₃SO₃⁻, (CF₃SO₂)₂N⁻ and C₄F₉SO₃⁻

“Intercalation” refers to the process wherein an ion inserts into a host material to generate an intercalation compound via a host/guest solid state redox reaction involving electrochemical charge transfer processes coupled with insertion of mobile guest ions, such as fluoride ions. Major structural features of the host material are preserved after insertion of the guest ions via intercalation. In some host materials, intercalation refers to a process wherein guest ions are taken up with interlayer gaps (e.g., galleries) of a layered host material. Examples of intercalation compounds include fluoride ion intercalation compounds wherein fluoride ions are inserted into a host material, such as a layered fluoride host material or carbon host material.

“Displacement” refers to the process in which an ion displaces another species. For example, species A may displace species B from binary phase BX, forming new binary phase AX and elemental B as a result. This reaction is a form of reconstitution reaction, in which one or more of the electrode materials is significantly changed or reconstituted.

The term “electrochemical cell” refers to devices and/or device components that convert chemical energy into electrical energy or electrical energy into chemical energy. Electrochemical cells have two or more electrodes (e.g., positive and negative electrodes) and an electrolyte, wherein electrode reactions occurring at the electrode surfaces result in charge transfer processes. Electrochemical cells include, but are not limited to, primary batteries, secondary batteries and electrolysis systems. General cell and/or battery construction is known in the art, see e.g., U.S. Pat. Nos. 6,489,055, 4,052,539, 6,306,540, Seel and Dahn J. Electrochem. Soc. 147(3) 892-898 (2000).

The term half-cell refers to an electrochemical device including two or more electrodes, wherein a first electrode serves as the counter electrode for ions transfer with electrolyte and/or serves as a reference electrode (e.g. metallic Li or Ag/AgF counter and reference electrodes), and a second electrode (the working electrode) includes the electrode material under study and characterization, such as a carbon coated metal fluoride electrode of this invention. Half-cells are useful for the study of electrodes to be ultimately used in a full electrochemical cell including a positive and a negative electrode.

The term “capacity” is a characteristic of an electrochemical cell that refers to the total amount of electrical charge an electrochemical cell, such as a battery, is able to hold. Capacity is typically expressed in units of ampere-hours. The term “specific capacity” refers to the capacity output of an electrode, per unit weight. Specific capacity is typically expressed in units of ampere-hours kg⁻¹. The specific capacity may be expressed based on the unit weight of active material in the battery.

The term “discharge rate” refers to the current at which an electrochemical cell is discharged. Discharge current can be expressed in units of ampere. Alternatively, discharge current can be normalized to the rated capacity of the electrochemical cell, and expressed as C/(X t), wherein C is the capacity of the electrochemical cell, X is a variable and t is a specified unit of time, as used herein, equal to 1 hour.

“Current density” refers to the current flowing per unit electrode area.

“Active material” refers to the material in an electrode that takes part in electrochemical reactions which store and/or delivery energy in an electrochemical cell.

As used herein, electrode refers to an electrical conductor where ions and electrons are exchanged with electrolyte and an outer circuit. “Positive electrode” and “cathode” are used synonymously in the present description and refer to the electrode having the higher electrode potential in an electrochemical cell (i.e. higher than the negative electrode). “Negative electrode” and “anode” are used synonymously in the present description and refer to the electrode having the lower electrode potential in an electrochemical cell (i.e. lower than the positive electrode). Cathodic reduction refers to a gain of electron(s) of a chemical species, and anodic oxidation refers to the loss of electron(s) of a chemical species.

“Electrode potential” refers to a voltage, usually measured against a reference electrode, due to the presence within or in contact with the electrode of chemical species at different oxidation (valence) states.

“Electrolyte” refers to an ionic conductor which can be in the solid state, the liquid state (most common), a gel state, or more rarely a gas (e.g., plasma).

“Cation” refers to a positively charged ion, and “anion” refers to a negatively charged ion.

In an embodiment, the invention provides an electrode for use in an electrochemical cell, the electrode comprising a current carrier and an electrode mixture comprising a plurality of fluoride-based nanomaterials, the fluoride materials being at least partially coated with an electrically conductive material and a polymeric binder, wherein at least a portion of the electrode mixture is in electrical contact with the current collector. The electrically conductive material can be carbon-based, a metal, or an electronically conductive polymer (e.g. conjugated polymer).

As used herein, a nanomaterial has at least one dimension that is between one nanometer and one micron. In an embodiment, at least one dimension of the nanomaterial is between 2 nm and 1000 nm. In another embodiment, the characteristic size of the nanomaterial is from 20 nm to 500 nm from 5 to 100 nm, or from 2 to 50 nm prior to carbon-coating. For nanotubes, nanofibers, nanowhiskers or nanorods the diameter of the tube, fiber, nanowhiskers or nanorod falls within this size range. For nanoparticles, the diameter of the nanoparticles falls within this size range.

In one aspect of the invention, a fluoride-based nanomaterial includes both fluorine and an element selected from the group consisting of alkali metals, alkaline earth metals, B, Al, Ga, In, Pb and lanthanides. Lanthanide metals include, but are not limited to, La and Ce. In an embodiment, the fluoride-based nanomaterials may be LaF₃ or CeF₃.

In an embodiment, the initial composition of fluoride-based nanomaterials useful for the invention may be described by the formula Caₓ M₁₋ₓFₙ, where is M is selected from alkali metals, alkaline-earth metals other than calcium, B, Al, Ga, In, lanthanides and a combination thereof, where the calcium molar composition x is 0.03≦x≦0.97 and 0<n≦3. As used herein, the initial composition is the composition before any charging (or discharging) of the cell. In an embodiment, the initial composition may be described by 0.03≦x≦0.97 where 0.5≦n≦3, 1.0≦n≦3 or 2.0≦n≦3. After loss of fluorine from the material, the composition may be such that x is 0.03≦x≦0.97 and 0≦n≦3, 0<n≦2 or 0.5≦n≦3. In an embodiment, the fluoride-based nanomaterial is a calcium doped lanthanide fluoride. In this embodiment, x may be from 0.03 to 0.15. In another embodiment, x is 0.5<x≦0.9 with n as specified previously, so that the nanomaterials are calcium fluoride-based.

In another embodiment, the initial composition of fluoride-based nanomaterials useful for the invention may be described by the formula CaFₘ, where 0<m≦2, 0.5≦m≦2, or 1.0≦m≦2. After loss of fluorine from the material, the composition may be such that 0≦m≦2, 0<m≦2 or 0.5≦m≦2. As used herein, a calcium fluoride need not be the compound CaF₂ (fluorite). As used herein, calcium fluorides are primarily composed of calcium and fluorine, but may also encompass varying amounts of impurities of elements other than calcium or fluorine. In different embodiments, the calcium fluoride may be at least 95% pure, at least 98% pure, at least 99% pure, or at least 99.5% pure. The initial composition of the calcium fluoride nanomaterials prior to use in an electrochemical cell may be fluorite (CaF₂). In an embodiment, the calcium fluoride nanomaterials may be nanoparticles or nanorods or nanowires.

In another embodiment, the initial composition of fluoride-based materials useful for the invention may be described by the formula Mgₓ M₁₋ₓFₙ, where is M is selected from alkali metals, alkaline-earth metals other than magnesium, B, Al, Ga, In, lanthanides and a combination thereof, where the magnesium molar composition ‘x’ is 0.03≦x≦0.97 and 0<n≦3. In another embodiment, x is 0.03≦x≦0.97 and 0.5≦n≦3, 1.0≦n≦3 or 2.0≦n≦3. After loss of fluorine from the material, the composition may be such that x is 0.03≦x≦0.97 and 0≦n≦3, 0<n≦2 or 0.5≦n≦3. In an embodiment, the fluoride-based nanomaterial is a magnesium doped lanthanide fluoride. In this embodiment, x may be from 0.03 to 0.15.

In another embodiment, the initial composition of the fluoride-based material may be described by MgFₘ, where 0<m≦2, 0.5≦m≦2, or 1.0≦m≦2. After loss of fluorine from the material, the composition may be such that 0≦m≦2, 0<m≦2 or 0.5≦m≦2. In different embodiments, the magnesium fluoride may be at least 95% pure, at least 98% pure, at least 99% pure, or at least 99.5% pure.

In another embodiment, the fluoride-based material may combine fluorine, an alkaline earth metal (Be, Mg, Ca, Sr, Ba or Ra) and a lanthanide (La, Ce, Pr, Nd, Pm, Sm, Eu, Gd, Tb, Dy, Ho, Er, Tm, Yb). The alkaline earth metal may be Mg, Ca or Sr, while the lanthanide may be La or Ce.

The use of the above formulas is not intended to imply that the material must be homogenous. For example, the material may contain a mixture of phases of different composition. As another example, the composition of the material may vary across the nanomaterial. For example, loss of fluorine from a nanoparticle will typically occur first from the surface of the particle and then progress inwards. In this case, the center of the nanoparticles may be richer in fluorine than locations near the outer surface. In different embodiment, the fluorine-based nanomaterials may be crystalline, polycrystalline, partially crystalline, or amorphous.

In an embodiment, a carbon-based film, carbonaceous particles, or a combination thereof are attached at least some of the fluoride-based nanomaterials of the electrode mixture. The coating provided by the film or particles may or may not be uniform. In an embodiment, the coating is not uniform over a given nanomaterial or from one nanomaterial to another. As another example, the carbon-based coating need not be uniform through the thickness of the electrode mixture. In different embodiments, the average thickness of the coating may be 2-100 nm, 1-10 nm or 1-5 nm. The amount of the coating may also be given in terms of the ratio of the weight of the carbon in the coating divided by sum of the weight of the carbon in the coating and the weight of the fluoride nanomaterials. In different embodiment, this weight percentage may be from 1-50%, from 1-25% or from 1-10%.

A variety of methods are known to the art for carbon coating of particles and other nanomaterials. Techniques known to the art include, but are not limited to, chemical vapor deposition, physical vapor deposition, and carbonization of a carbon-residue forming material. In an embodiment, at least some of the coating remains adherent to the nanomaterials after they have been processed into electrode form.

The carbon residue-forming material used to form a coating for the particles or other nanomaterials may be any material which, when thermally decomposed at a sufficiently high carbonization temperature, forms a residue which is “substantially carbon”. In an embodiment, “substantially carbon” indicates that the residue is at least 80-85% by weight carbon. Any organic compound that can be thermally decomposed to yield carbon residue can be used as the coating material. Exemplary useful coating materials include oils, polyvinylchloride (PVC), polyethers (e.g. PEG and PEO), polyesters, chemical process pitches; lignin from pulp industry; phenolic resins; carbohydrate materials such as sugars and polyacrylonitriles, heavy aromatic residues from petroleum, ascorbic acid and alkanes and alkenes which are solid at room temperature (e.g. greater than 13 carbon atoms). The coating may be applied by contacting the nanomaterials with the carbon residue-forming material followed by heat treatment. The heat treatment process may take place at a variety of temperatures; the heat treatment may also affect the structure of the fluorine-based nanomaterials. Heat treatment may take place under vacuum, in an inert atmosphere, or in a reactive gas atmosphere.

In another embodiment, a metal film or metal particles may be used to coat the particles or other nanomaterials and enhance the electronic conductivity of the electrode mixture. Suitable metals include, but are not limited to, Si, Ge, Sn, Pb, Al, Cu, Ni, Mn and combinations thereof. The thicknesses of the metal coating may be as specified above for the carbon coatings. In different embodiment, the weight percentage of metal (weight of the metal in the coating divided by sum of the weight of the metal in the coating and the weight of the fluoride nanomaterials) may be from 1-50%, from 1-25% or from 1-10%.

The electrode composition also includes a polymeric binder. In an embodiment, the polymeric binder is at least partially fluorinated. Exemplary binders thus include, without limitation, poly(ethylene oxide) (PEO), poly(vinylidene fluoride) (PVDF), a poly(acrylonitrile) (PAN), poly(tetrafluoroethylene) (PTFE), and poly(ethylene-co-tetrafluoroethylene) (PETFE). In different embodiment, the binders represent about 1 wt. % to about 30 wt. %, from 5 wt % to 25 wt % or from 5 wt % to 40 wt % of the electrode mixture.

Electrodes of the present invention may further comprises a conductive diluent, such as acetylene black, carbon black, powdered graphite, coke, carbon fiber, carbon nanotubes, carbon nanorods, carbon nanofibers and metallic powder. In an embodiment, the conductive diluent represents from 5 wt % to 40 wt % of the electrode mixture.

In different embodiments, the preferred weight percentage of the fluoride-based nanomaterial may be at least 20 wt %, 30 wt %, 40 wt %, or 50 wt %, from 25 wt % to 90 wt % or from 50 wt % to 90 wt %. In an embodiment, the amount of fluoride-based nanoparticles is from 25 wt % to 90 wt %, the amount of polymeric binder material is from 5 wt % to 40 wt % and the amount of conductive diluent is from 5 wt % to 40 wt %.

In an embodiment, the invention provides a fluoride ion (F) host electrode for use in an electrochemical cell. A “fluoride ion host electrode” includes a fluoride ion host material capable of accommodating fluoride ions. In this context, “accommodation” of anion charge carriers includes capture of anion charge carriers by the host material, insertion of anion charge carriers into the host material, intercalation of anion charge carriers into the host material and/or chemical reaction of anion charge carriers with the host material. Accommodation includes displacement and formation reactions, alloy formation chemical reactions, surface chemical reactions with the host material and/or bulk chemical reactions with the host material. In an embodiment, the fluoride ion acceptor electrode is capable of intercalation of fluoride ions into the fluoride-based nanomaterials present in the electrode.

Positive and negative electrodes of the present invention may be provided in a range of useful configurations and form factors as known in the art of electrochemistry and battery science, including thin electrode designs, such as thin film electrode configurations. Electrodes are manufactured as disclosed herein and as known in the art, including as disclosed in, for example, U.S. Pat. Nos. 4,052,539, 6,306,540, 6,852,446. For some embodiments, the electrode is typically fabricated by depositing a slurry of the electrode mixture and a liquid carrier on the electrode current collector, and then evaporating the carrier to leave a coherent mass in electrical contact with the current collector. Typically, the slurry formed upon admixture of the foregoing components is then deposited or otherwise provided on a conductive substrate to form the electrode. A variety of conductive substrates can be used, including, but not limited to, stainless steel, aluminum, copper, nickel, zinc, lead, titanium, platinum, gold, carbon coated metals or substrates coated with any of these metals (e.g. a metal substrate such as aluminum or copper coated with nickel).

In another aspect, the invention provides an electrochemical cell comprising:

a) a negative electrode of the invention;
b) a positive electrode; and
c) a nonaqueous electrolyte provided between said positive electrode and said negative electrode, said electrolyte being capable of conducting fluoride ions (F⁻); wherein said negative electrode reversibly exchanges said fluoride ions with said electrolyte during charging or discharging of said electrochemical cell

In the context of this description, the term “exchange” refers to release or accommodation of anion charge carriers at the electrodes via oxidation and reduction reactions during discharge or charging of the electrochemical cell. Reversible exchange of anions with the electrolyte does not require that the electrode faraday (charge) efficiency be 100%.

In an embodiment, an electrolyte of an electrochemical cell of the present invention comprises a solvent and a fluoride salt, wherein the fluoride salt is at least partially present in a dissolved state in the electrolyte so as to generate fluoride ions in the electrolyte. Electrolytes in electrochemical cells of the present invention include fluoride salts having the formula: MFₙ, wherein M is a metal, and n is an integer greater than 0. In some embodiments, for example, M is an alkali metal, such as Li, Na, K or Rb, or M is an alkaline earth metal, such as Mg, Ca or Sr. In some embodiments, the concentration of the fluoride salt in the electrolyte is selected from the range of about 0.1M to about 2.0M. In another embodiment, the fluoride salt is a nonmetallic fluoride salt containing N, P, As, Sb, Bi, S or Se.

Electrolytes for anionic electrochemical cells of the present invention, including fluoride ion electrochemical cells, include aqueous electrolytes and nonaqueous electrolytes. Useful electrolyte compositions for anionic electrochemical cells preferably have one or more of the following properties. First, electrolytes for some applications preferably have a high ionic conductivity with respect to the anion charge carrier, for example for fluoride ions. For example, some electrolytes useful in the present invention comprise solvents, solvent mixtures and/or additives providing conductivity for an anion charge carrier, such as a fluoride ion anion charge carrier, greater than or equal to 0.0001 S cm⁻¹, greater than or equal to 0.001 S cm⁻¹, or greater than or equal to 0.005 S cm⁻¹. Second, electrolytes for some embodiments are capable of dissolving an electrolyte salt, such as a fluoride salt, so as to provide a source of anion charge carriers at a useful concentration in the electrolyte. Third, electrolytes of the present invention are preferably stable with respect to decomposition at the electrodes. For example, electrolytes of an embodiment of the present invention comprises solvents, electrolyte salts, additives and anion charge carriers that are stable at both high and low electrode voltages, such as a difference between positive and negative electrode voltages equal to or greater than about 3.5 V or equal to or greater than about 4.5V. Fourth, electrolytes of the present invention preferable for some applications exhibit good safety characteristics, such as flame retardance.

Optionally, electrolytes of the present electrochemical cells include one or more additives. In an embodiment, the electrolyte comprises an anion receptor, such as fluoride ion anion receptors capable of coordinating fluoride ions of a fluoride salt, and/or a cation receptor, for example a cation receptor capable of coordinating metal ions of a fluoride salt. Useful anion receptors in the present invention include, but are not limited to, fluorinated boron-based anion receptors having electron withdrawing ligands, such as fluorinated boranes, fluorinated boronates, fluorinated borates, phenyl boron-based compounds and aza-ether boron-based compounds. Useful cation receptors for electrolytes of electrochemical cells of the present invention include, but are not limited to, crown ethers, lariat ethers, metallacrown ethers, calixcrowns (e.g., calyx(aza)crowns), tetrathiafulvalene crowns, calixarenes, calix[4]arenediquinoes, tetrathiafulvalenes, bis(calixcrown)tetrathiafulvalenes, and derivatives thereof. In some embodiments, electrolytes of the present invention comprise other inorganic, organic or gaseous additives. Additives in electrolytes of the present invention are useful for: (i) enhancing conductivity of the anion charge carrier, (ii) decreasing flammability, (iii) enhancing electrode wetting, (iv) decreasing electronic conductivity, and (v) enhancing the kinetics of anion charge carriers at the electrodes, for example by enhancing formation of a solid electrolyte interface (SEI) or by reducing the buildup of discharge products. In an embodiment, the electrolyte comprises a Lewis acid or a Lewis base such as, but not limited to

BF₄⁻, PF₆⁻, AsF₆⁻, SbF₆⁻, BiF₆⁻, AlF₄⁻, GaF₄⁻, InF₄⁻, TlF₄⁻, SiF₅⁻, GeF₅⁻, SnF₅⁻, PbF₅⁻, SF₇⁻, IF₆⁻, ClO₄⁻, CF₃SO₃⁻, (CF₃SO₂)₂N⁻, C₄F₉SO₃⁻ and NR₄⁺ (R═H or an alkyl group CₙH₂ₙ₊₁ n=integer).

As described in US Patent Application Publication US 2009/0029237, the open-circuit voltage in a fluoride ion electrochemical cell results, at least in part, from differences in the chemical potential of the fluoride ions in the negative electrode and the positive electrode. The positive electrode and negative electrode are respectively a high voltage and a low voltage fluorides, able to reversible exchange F⁻ with electrolyte. In an embodiment, neither electrode of the electrochemical cell consists of lithium metal or a metallic lithium alloy.

Useful fluoride ion host materials for positive electrodes of electrochemical cells of the present invention include, but are not limited to, CFx, AgFx, CuFx, NiFx, CoFx, PbFx, CeFx, MnFx, AuFx, PtFx, RhFx, VFx, OsFx, RuFx and FeFx. In an embodiment, the fluoride ion host material of the positive electrode is a subfluorinated carbonaceous material having a formula CFx, wherein x is the average atomic ratio of fluorine atoms to carbon atoms and is selected from the range of about 0.3 to about 1.0. Carbonaceous materials useful for positive electrodes of this embodiment are selected from the group consisting of graphite, coke, multiwalled carbon nanotubes, multi-layered carbon nanofibers, multi-layered carbon nanoparticles, carbon nanowhiskers and carbon nanorods. The present invention also includes positive electrode fluoride ion host materials comprising a polymer(s) capable of reversibly exchanging fluoride ions comprising the anion ion charge carriers. Examples of conjugated polymers for positive electrodes include, but not limited to: polyacetylene, polyaniline, polypyrrol, polythiophene and polyparaphenylene.

In another embodiment, the fluoride ion host material used for the positive electrode may comprise a plurality of carbon nanomaterials having a curved multilayered structure and a metal-based film or metal-based nanoparticles deposited onto at least some of the carbon nanomaterials as described in US application Ser. No. 12/509,306. As used herein, a carbon nanomaterial has at least one dimension that is between one nanometer and one micron. In an embodiment, at least one dimension of the nanomaterial is between 2 nm and 1000 nm. For carbon nanotubes, nanofibers, nanowhiskers or nanorods the diameter of the tube, fiber, nanowhiskers or nanorod falls within this size range. For carbon nanoparticles, the diameter of the nanoparticle falls within this size range. Carbon nanomaterials suitable for use with the invention include materials which have total impurity levels less than 10% and carbon materials doped with elements such as boron, nitrogen, silicon, tin and phosphorous.

Carbon nanomaterials suitable for use in this embodiment have multiple carbon layers prior to fluorination. In an embodiment, the carbon layers are curved; such as concentric or scroll-like layers. For multiwalled nanotubes, the layers are formed by the graphene layers which make up the walls of the nanotube. For multilayered nanoparticles, the layers are formed by multilayered fullerenes.

As used herein, the term “nanotube” refers to a tube-shaped discrete fibril typically characterized by a diameter of typically about 1 nm to about 20 nm. In addition, the nanotube typically exhibits a length greater than about 10 times the diameter, preferably greater than about 100 times the diameter. The term “multi-wall” as used to describe nanotubes refers to nanotubes having a layered structure, so that the nanotube comprises an outer region of multiple continuous layers of ordered atoms and a distinct inner core region or lumen. The layers are disposed substantially concentrically about the longitudinal axis of the fibril. For carbon nanotubes, the layers are graphene layers. Carbon nanotubes have been synthesized in different forms as Single-, Double- and Multi-Walled Carbon Nanotubes noted SWCNT, DWCNT and MWCNT respectively. The diameter size ranges between about 2 nm in SWCNTs and DWCNTs to about 20 nm in MWCNTs. In an embodiment, the MWNT used in the invention have a diameter greater than 5 nm, greater than 10 nm, between 10 and 20 nm, or about 20 nm.

Multi-walled carbon nanotubes can be produced by catalytic chemical vapor deposition (CVD). In an embodiment, carbon nanotubes produced by CVD are heat treated to improve their structural and micro textural characteristics before undergoing the fluorination process of the invention. In particular, the carbon nanotubes are heated to a sufficiently high temperature so that the graphene layers become substantially straight and well aligned with the tube axis. In an embodiment, the MWCNT are heated to produce a substantially well ordered structure. As used herein, a carbon nanostructure is substantially well ordered when it has at least one peak in its X-ray diffraction pattern, which peak 1) appears in the angular area comprised between 24.5 degrees and 26.6 degrees in the diffraction angle 2 theta, using a copper monochromatic radiation, and 2) has a full width at half maximum of less than 4 degrees in the 2 theta diffraction angle.

As used herein, carbon nanofibers refer to carbon fibers having a diameter greater than 20 nm and less than 1000 nm. In different embodiments, the carbon nanofibers used in the invention are between 20 and 1000 nm, between 40 and 1000 nm or between 80 and 350 nm. Carbon nanofibers having concentric carbon layers similar to those of multi-walled nanotubes can be produced by catalytic chemical vapor deposition and heat treatment. In particular, the CVD-produced carbon nanofibers are heated to a sufficiently high temperature so that the carbon layers become substantially straight and well aligned with the fiber axis. In different embodiments, the carbon nanofibers are heated to a temperature greater than greater than 1800° C., or greater than 2500° C. to produce a substantially well ordered structure.

As is known in the art, vapor-grown carbon fibers (VGCF) with larger diameters (e.g. 10 microns) can also be produced by catalytic chemical vapor deposition. These fibers can have a structure of layer-like growth rings which lie concentrically on top of each other (Endo, M., 1988, Chemtech, 568-576). VGCF having a diameter of one micron or greater are not intended by be encompassed by the term “carbon nanomaterials” as used in the present invention.

Carbon nanoparticles can be thought of as structures related to large, rather imperfect multilayered fullerenes (Harris, P., 1999, “Carbon Nanotubes and Related Structures”, Cambridge University Press, Cambridge, p. 103). One form of carbon nanoparticle is referred to as a “carbon onion.” When fully formed, carbon onions appear highly perfect in structure and have few obvious defects (Harris 1999). Carbon onions have been formed with diameters in excess of 5 nm (Harris 1999). Nasibulin et al. report formation of carbon onions between 5 nm and 30 nm (Nasimbulin, A. G., et al, 2005, Colloid J., 67(1), 1-20), while Sano et al. report formation of carbon onions between 4 and 36 nm (Sano, N. et al, 2002, J. Appl. Phys., 92(5), 2783). In different embodiments, the multi-walled carbon nanoparticles used in the invention have a diameter greater than 5 nm, greater than 10 nm, greater than 20 nm, between 5 and 35 nm, or between 10 and 30 nm.

One form of carbon nanorods, grown by electron cyclotron resonance chemical vapor deposition, was reported by Woo et al. The filamentous carbon did not form a hollow tube. High resolution transmission electron microscopy was reported to show crystalline walls, with the graphene layers being somewhat disordered and slanted about the rod axis. The average distance between the graphene layers was reported to be larger than that in MWCNT (Woo, Y. et al., 2003 J. Appl. Phys. 94(10, 6789).

Carbon whiskers, also known as graphite whiskers, are known to the art. These materials appear to have a scroll-like structure made up of an essentially continuous graphitic structure (Harris 1999).

The carbon nanostructures may be subjected to particle beam irradiation prior to their use in an electrochemical cell. Suitable forms of particle beam irradiation include, but are not limited to, electron beam irradiation, ion irradiation (including hydrogen ion/proton beam irradiation), neutron irradiation, gamma-ray irradiation and x-ray irradiation. It is known to the art that particle irradiation can produce defects in carbon materials. In an embodiment, carbon structure following particle beam irradiation contains point defects, but the outer walls or layers of the carbon nanostructure retain a graphene layer structure, although the average interlayer spacing may increase. In an embodiment, X-ray diffraction analysis of the irradiated carbon nanomaterials still shows a distinct peak in angular area comprised between 24.5 degrees and 26.6 degrees in the diffraction angle 2 theta, using a copper monochromatic radiation. In an embodiment, the irradiation type, energy and dose is selected in order to retain at least a partial of the graphene layer structure. Ishaq et al. (2009, Materials Letters, 63 (2009) 1505-1507) describe irradiation energies and doses at which a graphite to amorphous structure transformation of multiwalled carbon nanotubes occurs under proton beam irradiation.

In another embodiment, the carbon nanostructures may be subjected to chemical treatment prior to their use in an electrochemical cell. In an embodiment, the chemical treatment may involve contacting the carbon nanostructures with a strong acid. Such treatments are known in the art for opening the ends of nanotube structures.

In an embodiment, the carbon nanostructures are not in the form of an array.

In an embodiment, a metal-based film, particles, or a combination thereof are attached at least some of the multi-walled carbon nanomaterials of the positive electrode mixture. The coating provided by the film or particles may or may not be uniform. In an embodiment, the coating is not uniform over a given nanomaterial or from one nanomaterial to another. For example, metal particles may be deposited on one portion of a given multi-walled nanotube, but may not be present on another portion of the nanotube. For a metal film, the film need not be continuous. As another example, the metal coating need not be uniform through the thickness of the electrode mixture.

In an embodiment, the metal is a transition metal. In an embodiment, the transition metal is selected from the group consisting of Cu, Ag, Au, Pt, Hg and combinations thereof. In another embodiment, the metal is selected from the group consisting of Cu, Ag, and Au and combinations thereof. In an embodiment, the metal is a noble metal. In an embodiment, the metal is Ag. The metal may also be selected from group IIIA of the periodic table, such as Al, In or combinations thereof. The metal may also be selected from group IVA of the periodic table, such as Sn, Pb or combinations thereof.

In an embodiment, a metal or nonmetal-based material may be attached to the carbon nanomaterials, the metal or nonmetal being selected so that it reacts with fluorine. In an embodiment, the metal or non-metal reacts with fluorine to form a fluoride compound. This fluoride compound may or may not be stable under the conditions present in the electrochemical cell.

In another embodiment, the metal or nonmetal is selected to form a high oxidation state in a fluoride which is unstable. Without wishing to be bound by any particular belief, during the charge process the following reactions may occur (illustrated for a metal):

M+nF—<=>MFₙ+ne- (5)

MFₙ+xC<=>MFₙ₋₁+(CₓF) (6)

with formation of MFn, an unstable metal fluoride, allowing the transfer of F anions from electrolyte to the MWNF cathode

Elements which are believed to form a high oxidation state in a fluoride include Cu, Ag, Au, V, Cr, Mn, Co, Ni, Tc, Ru, Rh, Pd, Re, Os, Ir, Pt, Ce, Pr, Nd, Tb, Dy, Np, Pu, Am, Bp, Cf, Es, As, Bi, S, Se, Te, and Cl. In an embodiment, the element is a transition metal. In another embodiment, the element is a lanthanide or actinide. In another embodiment, the element is nonmetallic, such as As, Bi, S, Se, Te, and Cl.

A variety of techniques for metal deposition are known to the art. These include, but are not limited to, precipitation, electrodeposition, chemical vapor deposition, and physical vapor deposition. In different embodiments the average thickness of the film or diameter of the particles is less than 1 micron, less than 500 nm, less than 200 nm, or less than 50 nm. In other embodiments, the film thickness or particle diameter is from 1 nm to 500 nm, 1 nm to 200 nm, 1 nm to 100 nm, or 10 nm to 150 nm.

In different embodiments, the average atomic ratio percentage of metal to carbon (100*moles M/moles C) or molar percentage of metal (100*moles M/(moles M+moles C) is from 1 to 80%, 1 to 70%, 1 to 60%, 1 to 40%, from 1 to 30%, or from 5 to 40%. When the metal coating is not uniform, the local atomic ratio of metal to carbon may vary within the electrode mixture. Similar ranges can apply to nonmetallic elements.

In other embodiments, the average weight ratio percentage (100*% wt M/wt C) or weight percentage (100*wt M/(wt M+wt C)) of metal is from 1% to 95%, from 1 to 75 wt %, from 5 to 75 wt %, or from 5 to 60 wt %. Similar ranges can apply to nonmetallic elements.

### STATEMENTS REGARDING INCORPORATION BY REFERENCE AND VARIATIONS

All references throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments, exemplary embodiments and optional features, modification and variation of the concepts herein disclosed may be resorted to by those skilled in the art, and that such modifications and variations are considered to be within the scope of this invention as defined by the appended claims. The specific embodiments provided herein are examples of useful embodiments of the present invention and it will be apparent to one skilled in the art that the present invention may be carried out using a large number of variations of the devices, device components, methods steps set forth in the present description. As will be obvious to one of skill in the art, methods and devices useful for the present methods can include a large number of optional composition and processing elements and steps.

When a group of substituents is disclosed herein, it is understood that all individual members of that group and all subgroups, including any isomers, enantiomers, and diastereomers of the group members, are disclosed separately. When a Markush group or other grouping is used herein, all individual members of the group and all combinations and subcombinations possible of the group are intended to be individually included in the disclosure. When a compound is described herein such that a particular isomer, enantiomer or diastereomer of the compound is not specified, for example, in a formula or in a chemical name, that description is intended to include each isomers and enantiomer of the compound described individual or in any combination. Additionally, unless otherwise specified, all isotopic variants of compounds disclosed herein are intended to be encompassed by the disclosure. For example, it will be understood that any one or more hydrogens in a molecule disclosed can be replaced with deuterium or tritium. Isotopic variants of a molecule are generally useful as standards in assays for the molecule and in chemical and biological research related to the molecule or its use. Methods for making such isotopic variants are known in the art. Specific names of compounds are intended to be exemplary, as it is known that one of ordinary skill in the art can name the same compounds differently.

The molecules disclosed herein may contain one or more ionizable groups [groups from which a proton can be removed (e.g., —COOH) or added (e.g., amines) or which can be quaternized (e.g., amines)]. All possible ionic forms of such molecules and salts thereof are intended to be included individually in the disclosure herein. With regard to salts of the compounds herein, one of ordinary skill in the art can select from among a wide variety of available counterions those that are appropriate for preparation of salts of this invention for a given application. In specific applications, the selection of a given anion or cation for preparation of a salt may result in increased or decreased solubility of that salt.

Every formulation or combination of components described or exemplified herein can be used to practice the invention, unless otherwise stated.

Whenever a range is given in the specification, for example, a temperature range, a time range, or a composition or concentration range, all intermediate ranges and subranges, as well as all individual values included in the ranges given are intended to be included in the disclosure. It will be understood that any subranges or individual values in a range or subrange that are included in the description herein can be excluded from the claims herein.

All patents and publications mentioned in the specification are indicative of the levels of skill of those skilled in the art to which the invention pertains. References cited herein are incorporated by reference herein in their entirety to indicate the state of the art as of their publication or filing date and it is intended that this information can be employed herein, if needed, to exclude specific embodiments that are in the prior art. For example, when composition of matter are claimed, it should be understood that compounds known and available in the art prior to Applicant's invention, including compounds for which an enabling disclosure is provided in the references cited herein, are not intended to be included in the composition of matter claims herein.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of” and “consisting of” may be replaced with either of the other two terms. The invention illustratively described herein suitably may be practiced in the absence of any element or elements, limitation or limitations which is not specifically disclosed herein.

One of ordinary skill in the art will appreciate that starting materials, biological materials, reagents, synthetic methods, purification methods, analytical methods, assay methods, and biological methods other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

### Example 1

### Carbon-Coated Calcium Fluoride Nanoparticles

Nanosized calcium fluoride was prepared by a co precipitation method in which calcium nitrate reacts with ammonium fluoride in an aqueous solution. The mixture was kept under vigorous stirring for half an hour. The powder was then separated from the solution by centrifugation and the precipitate was washed several with ethanol before an overnight drying under vacuum at 90° C. The nature and the size of the particles were checked by X-ray Diffraction.

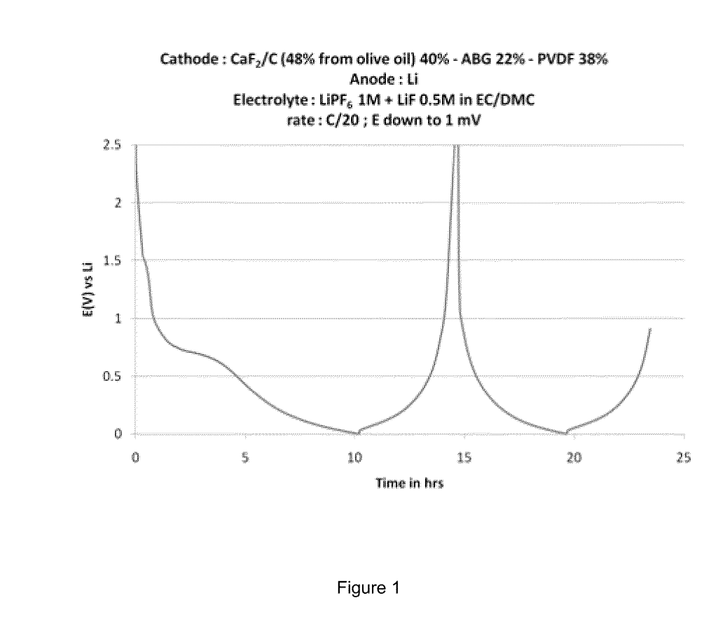

The calcium fluoride particles were then coated with carbon. To achieve this goal, the powder was first coated with olive oil in acetone. The suspension was mixed under vigorous magnetic stirring and in an ultrasonic bath. The acetone was then removed by evaporation and the mixture was dried for an hour at 80° C. The oil coated calcium fluoride was then put in a tube furnace at 600° C. for 2 hours under a helium flux in order to burn the olive oil and to coat the calcium fluoride particles with carbon. The amount of carbon needed for the coating was calculated by taking into account the specific surface of the fluoride powder (estimated from the particle size) and a target coating thickness of about 3 nm for a uniform coating. In FIG. 1, the weight percentage of carbon (48 wt %) was calculated from the amount of olive oil added to the calcium fluoride powder.

The carbon coated calcium fluoride powder was mixed with ABG (partially graphitized conductive carbon) and PVDF (PolyVinyliDene Fluoride) as a polymer binder. The mixture was suspended in acetone and magnetically stirred for about an hour. Once the viscosity became high enough (after acetone evaporation), the slurry was poured on a flat aluminum foil and dried in the air. Sixteen millimeter diameter electrodes were punched from the as formed thin foil.

A 2016 coin cell was prepared with the as prepared carbon coated calcium fluoride electrode in a controlled dry atmosphere glove box. The anode was metallic lithium and the cathode was the carbon coated calcium fluoride electrode. The separator (fiber glass) is soaked with the electrolyte that has the following composition: 1M LiPF₆+0.5M LiF in a 1:1 EC/DMC dry solvent. A stainless steel spacer was placed between the +can of the coin cell and the cathode. The sandwich was then pressed and sealed inside the glove box. This cell was a half cell used for studying the performance of the carbon-coated calcium fluoride containing electrode.

FIG. 1 shows charge-discharge profiles of a cell with a carbon coated calcium fluoride containing electrode, a lithium electrode and a 1M LiPF6+0.5 M LiF in 1:1 EC/DMC electrolyte. The carbon coating was formed using olive oil as a precursor-48%. The cathode composition for the half cell was carbon coated CaF₂ 40 wt %, ABG 22 wt % and PVDF 38 wt %. The anode was lithium. The rate was C/20; the voltage was decreased to 1 mV.

### Example 2

### Carbon-Coated Calcium Doped Cerium Fluoride Nanoparticles

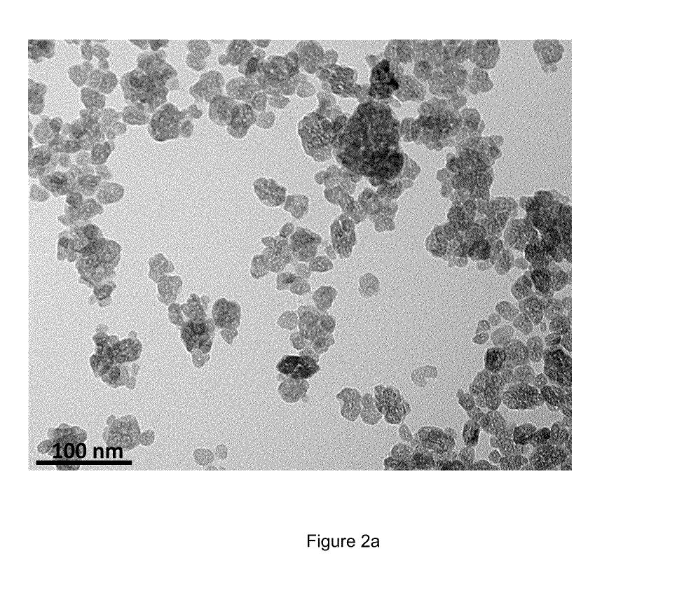

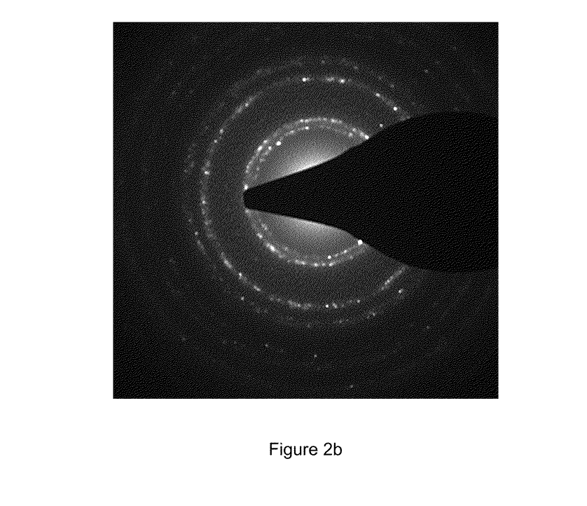

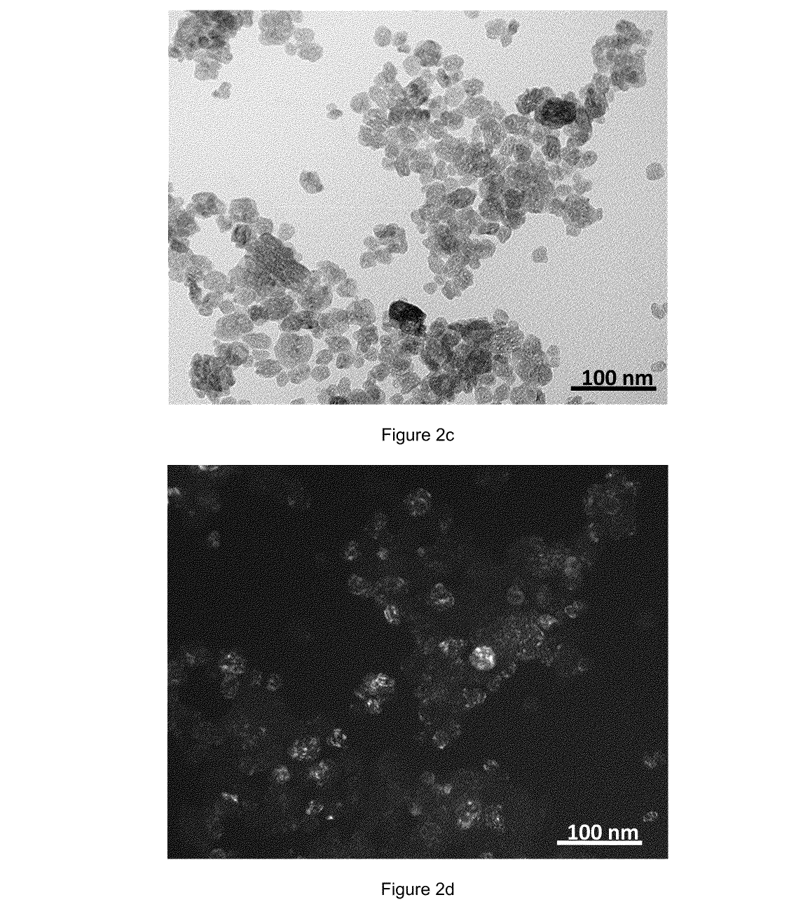

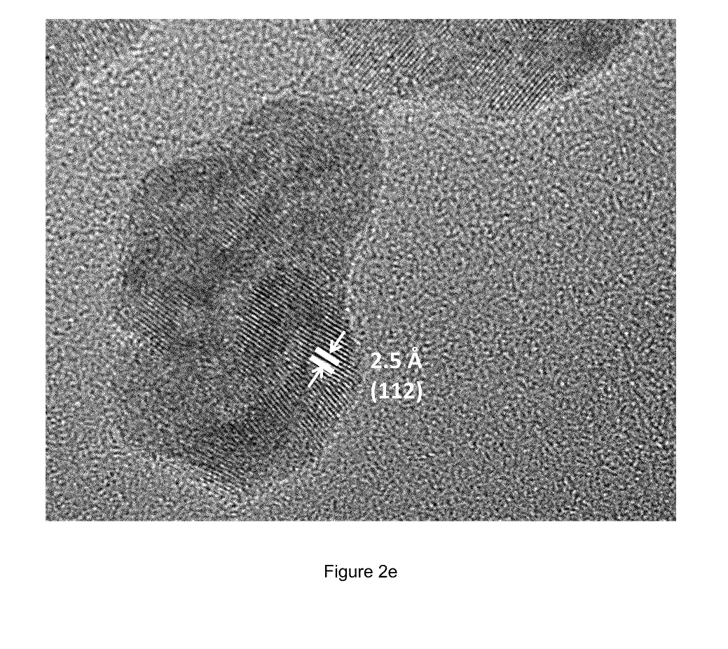

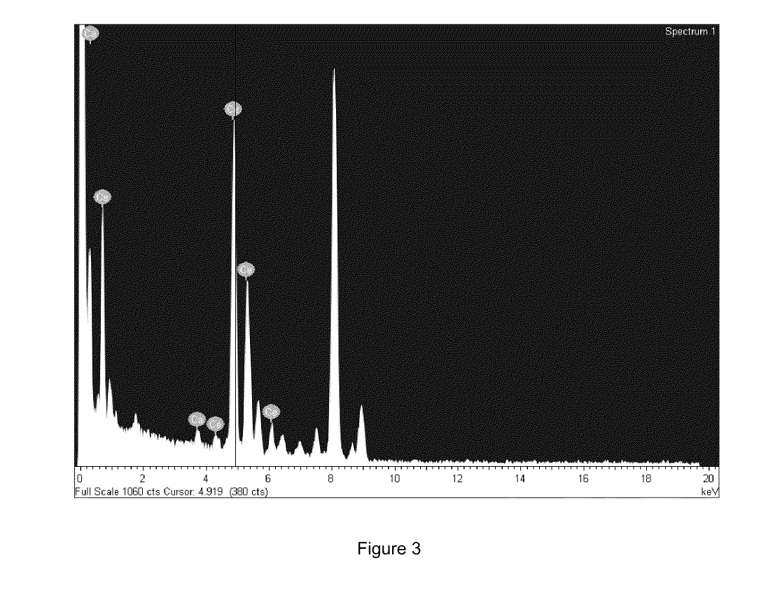

Nanosized calcium doped cerium fluoride particles were prepared by a co precipitation method similar to that described in Example 1. Cerium nitrate and calcium nitrate were reacted with ammonium fluoride in an aqueous solution. FIG. 2a shows a transmission electron microscope (TEM) image of several particles; the average particle size was about 20 nm. FIG. 2b shows a selected area diffraction image of particles from FIG. 2a; this image indicates that the particles have some crystalline character (polycrystalline). FIGS. 2c and 2d show bright and dark field TEM images, respectively. The light areas in the dark field image indicate cerium fluoride. FIG. 2e shows a higher resolution TEM image of a particle. The spacing of the (112) planes was 2.5 Angstroms. FIG. 3 shows a plot obtained by Energy Dispersive X-Ray (EDX) analysis; the amount of calcium determined from EDX analysis was 4.7% (the ratio of calcium to cerium in the salt mixture was about 4.9%; the peaks at about 0.3 and about 3.7 keV are labeled as calcium peaks; the rest of the labeled peaks are identified as cerium).

The carbon coating was applied in a similar manner to that in Example 1, except that a wider variety of carbon precursors were used (including sugar, ascorbic acid, and olive oil).

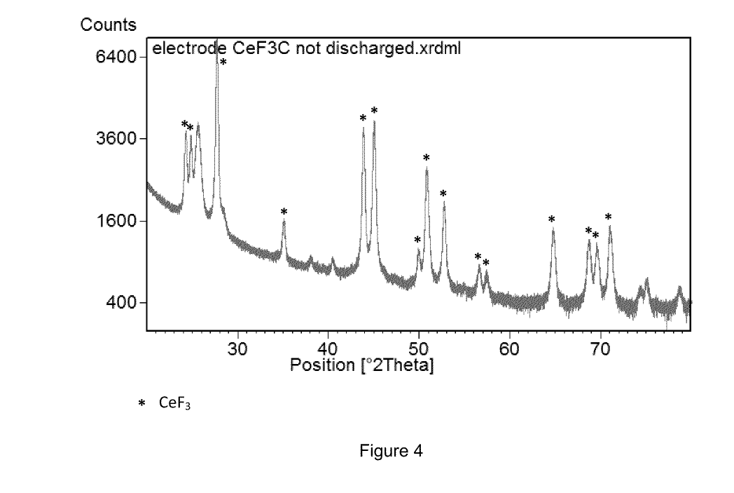

The calcium doped cerium fluoride containing electrode was prepared in a similar manner to the calcium fluoride containing electrode of Example 1. FIG. 4 shows an x-ray diffraction spectrum of the electrode before discharge in a lithium half cell. The asterisks indicate peaks characteristic of CeF₃. No peaks characteristic of CaF₂ were observed, indicating that the calcium is likely to be in solid solution. Some of the unlabeled peaks present in the spectrum may be due to carbon.

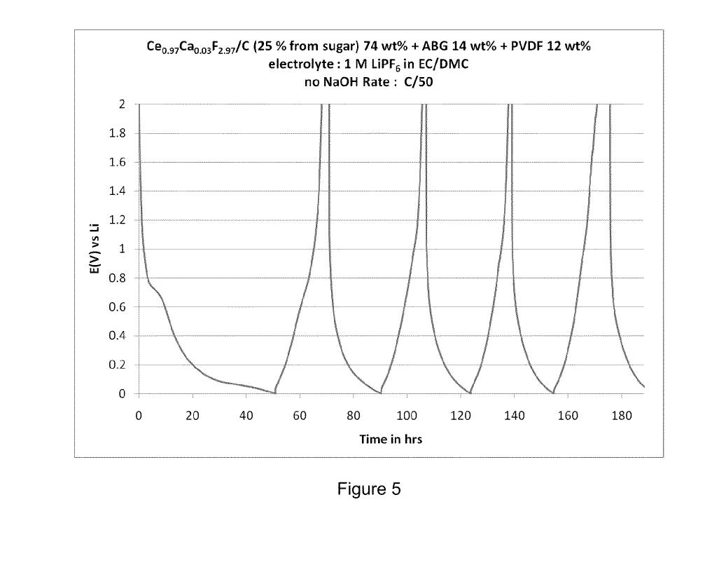

The carbon coated calcium doped cerium fluoride nanoparticles containing electrodes were tested in an electrochemical cell with a lithium electrode. FIG. 5 shows charge-discharge profiles of a cell with a carbon coated calcium doped cerium fluoride containing electrode, a lithium electrode and a 1M LiPF6 in 1:1 EC/DMC electrolyte. The carbon coating was formed using sugar as a precursor-25%. The cathode composition for the half cell was carbon coated Ce_{0.97}Ca_{0.03}F_{2.97} 74 wt %, ABG 14 wt % and PVDF 12 wt %. The anode was lithium. The rate was C/50.

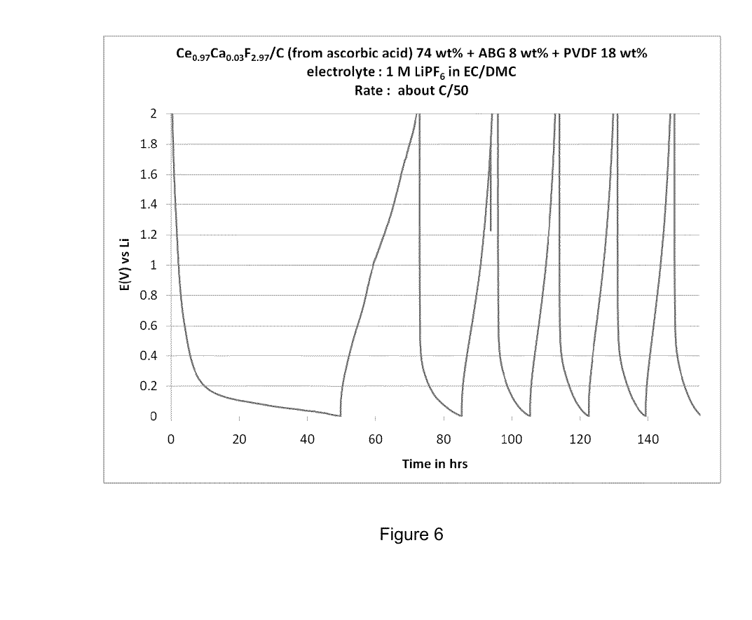

FIG. 6 shows charge-discharge profiles of a cell with a carbon coated calcium doped cerium fluoride containing electrode, a lithium electrode and a 1M LiPF6 in 1:1 EC/DMC electrolyte. The carbon coating was formed using ascorbic acid as a precursor. The cathode composition for the half cell was carbon coated Ce_{0.97}Ca_{0.03}F_{2.97} 74 wt %, ABG 8 wt % and PVDF 18 wt %. The anode was lithium. The rate was about C/50.

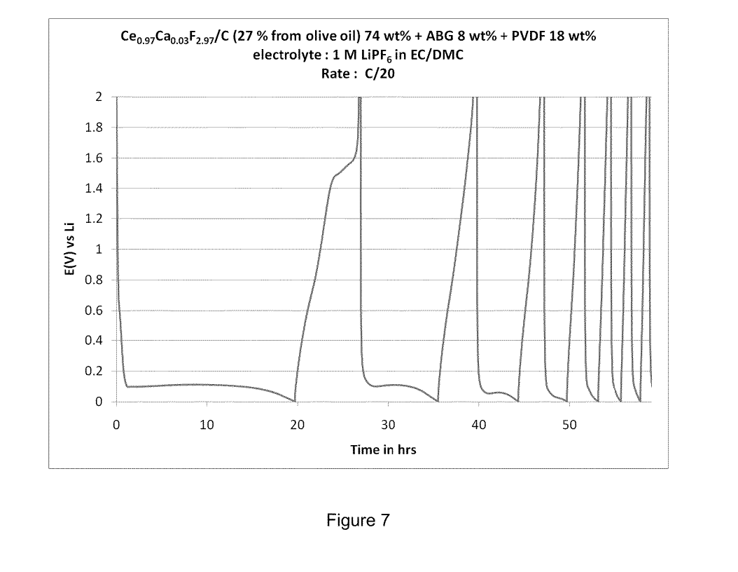

FIG. 7 shows charge-discharge profiles of a cell with a carbon coated calcium doped cerium fluoride containing electrode, a lithium electrode and a 1M LiPF6 in 1:1 EC/DMC electrolyte. The carbon coating was formed using olive oil as a precursor-27%. The cathode composition for the half cell was carbon coated Ce_{0.97}Ca_{0.03}F_{2.97} 74 wt %, ABG 8 wt % and PVDF 18 wt %. The anode was lithium. The rate was C/20.

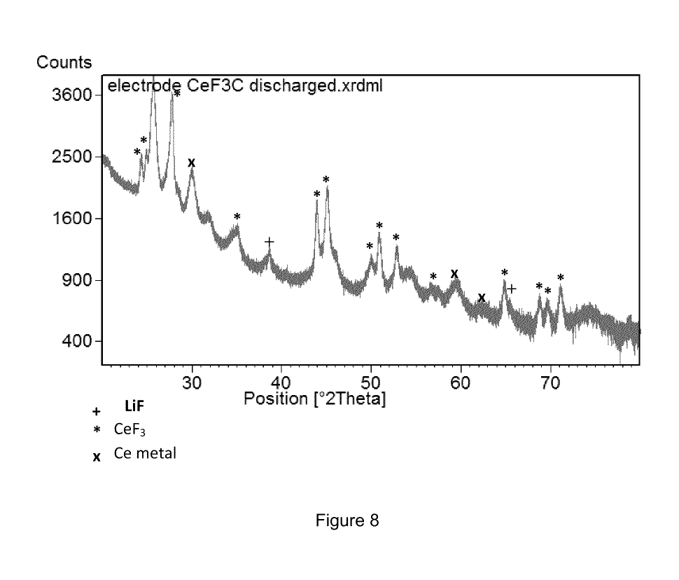

FIG. 8 shows an x-ray diffraction spectrum of the electrode after discharge in a cell with a lithium electrode. The asterisks indicate peaks characteristic of CeF₃, Ce metal and LiF. These results are consistent with the displacement reaction: CeF₃+3 Li⁺+3e⁻→Ce+3LiF.

We claim:

1. An electrode for use in an electrochemical cell, the electrode comprising
a. an electrode mixture comprising
i) a plurality of fluoride-based nanomaterials comprising calcium or magnesium, the fluoride-based nanomaterials being at least partially coated with an electrically conductive material;
ii) a polymeric binder material; and
b. a current collector
wherein the coated fluoride-based nanomaterials comprise at least 25% by weight of the electrode mixture and at least a portion of the electrode mixture is in electrical contact with the current collector.

2. The electrode of claim 1, wherein the fluoride-based nanomaterials are calcium fluoride nanoparticles or nanowires.

3. The electrode of claim 1, wherein the fluoride-based nanomaterials have the formula Caₓ M₁₋ₓFₙ, where is M is selected from alkali metals, alkaline-earth metals other than calcium, B, Al, Ga, In, lanthanides and combinations thereof, wherein the calcium molar composition x is 0.03≦x≦0.97 and 0<n≦3.

4. The electrode of claim 1, wherein the electrically conductive material is a carbon-based.

5. The electrode of claim 1, wherein the average size of the fluoride-based nanomaterials is from 20 nm to 500 nm prior to coating.

6. The electrode of claim 1, wherein the electrode mixture further comprises a conductive diluent.

7. The electrode of claim 6, wherein the amount of fluoride-based nanoparticles is from 25 wt % to 90 wt %, the amount of polymeric binder material is from 5 wt % to 40 wt % and the amount of conductive diluent is from 5 wt % to 40 wt %.

8. An electrochemical cell comprising:
a) a first electrode comprising;
i) an electrode mixture comprising
a plurality of fluoride-based nanomaterials comprising calcium or magnesium, the fluoride-based nanomaterials being at least partially coated with an electrically conductive material;
a polymeric binder material; and
ii) a current collector
wherein the coated fluoride-based nanomaterials comprise at least 25% by weight of the electrode mixture and at least a portion of the electrode mixture is in electrical contact with the current collector;
b) a second electrode;
c) a nonaqueous electrolyte provided between said first and second electrodes, said electrolyte being capable of conducting fluoride ions (F⁻); wherein said first electrode reversibly exchanges said fluoride ions with said electrolyte during charging or discharging of said electrochemical cell.

9. The electrochemical cell of claim 8, wherein the fluoride-based nanomaterials are calcium fluoride nanoparticles or nanowires.

10. The electrochemical cell of claim 8, wherein the fluoride-based nanomaterials have the formula Caₓ M₁₋ₓFₙ, where is M is selected from alkali metals, alkaline-earth metals other than calcium, B, Al, Ga, In, lanthanides and combinations thereof, wherein the calcium molar composition x is 0.03≦x≦0.97 and 0<n≦3.

11. The electrode of claim 8, wherein the electrically conductive material is carbon-based.

12. The electrochemical cell of claim 8, wherein the average size of the fluoride-based nanomaterials is from 20 nm to 500 nm prior to coating.

13. The electrochemical cell of claim 8, wherein the electrode mixture further comprises a conductive diluent and the amount of fluoride-based nanoparticles is from 25 wt % to 90 wt %, the amount of polymeric binder material is from 5 wt % to 40 wt % and the amount of conductive diluent is from 5 wt % to 40 wt %.

14. The electrochemical cell of claim 8 wherein said electrolyte comprises a solvent and a fluoride salt, wherein said fluoride salt is at least partially present in a dissolved state in said electrolyte, thereby generating said fluoride ions in said electrolyte.

15. The electrochemical cell of claim 14, wherein said fluoride salt has the formula MFₙ, wherein M is an alkali metal or an alkaline earth metal.

16. The electrochemical cell of claim 15, wherein said fluoride salt comprises LiF.

17. The electrochemical cell of claim 8, wherein said first electrode is a negative electrode and said second electrode is a positive electrode.

18. The electrochemical cell of claim 17, wherein said negative electrode reversibly exchanges fluoride ions with said electrolyte during charging or discharging of said electrochemical cell.

19. A method for generating an electrical current, the method comprising the steps of:
a) providing an electrochemical cell according to claim 8; and
b) discharging the electrochemical cell.

20. The method of claim 19, wherein the fluoride-based nanomaterials are calcium fluoride nanoparticles or nanowires

21. The method of claim 19, wherein the fluoride-based nanomaterials have the formula Caₓ M₁₋ₓFₙ, where is M is selected from alkali metals, alkaline-earth metals other than calcium, B, Al, Ga, In, lanthanides and combinations thereof, wherein the calcium molar composition x is 0.03≦x≦0.97 and 0<n≦3.
